(19) United States
(12) Patent Application Publication
(10) Pub. No.: US 2025/0179396 A1
(43) Pub. Date: Jun. 5, 2025

(54) FRAGRANCE-CONTAINING GRANULES

(71) Applicant: International Flavors & Fragrances Inc., New York, NY (US)

(72) Inventors: Franklin Albert Pringgosusanto, Manalapan, NJ (US); Joseph Brain, Holmdel, NJ (US); Christopher Thomas Lavallee, Union Beach, NJ (US)

(21) Appl. No.: 18/843,454

(22) PCT Filed: Mar. 7, 2023
(86) PCT No.: PCT/US2023/014692

§ 371 Date: Sep. 3, 2024

Related U.S. Application Data
(60) Provisional application No. 63/317,183, filed on Mar. 7, 2022.

(51) Int. Cl. C11D 3/50; C11D 3/22; D06M 13/00; D06M 15/03; D06M 23/08; D06M 23/12

(52) U.S. Cl. CPC C11D 3/505; C11D 3/222; D06M 13/005; D06M 15/03; D06M 23/08; D06M 23/12; C11D 2111/12

(57) ABSTRACT

This disclosure relates to a fragrance-containing granule that includes (a) a fragrance material comprising a neat fragrance and an encapsulated fragrance; and (b) a carbohydrate carrier; wherein the amount of the fragrance material is greater than 40 wt %, 45 wt %, 50 wt %, 55 wt %, or 60 wt %, based on the weight of the granule; the weight ratio of the neat fragrance to the encapsulated fragrance is from 10:1 to 1:1; and the granule has a skeletal density of greater than 1.00 g/mL or 1.05 g/mL.

### FIELD OF THE DISCLOSURE

The present disclosure relates to high load fragrance-containing granules with improved performance and/or fragrance benefits, particularly as compared to particles produced from existing technologies (e.g., melt-pastillation, spray-dried particles) and/or materials (e.g., PEG). The present disclosure also relates to methods of making such granules, consumer products containing such granules and methods of use thereof.

### BACKGROUND OF THE DISCLOSURE

Fragrances play a critical role to delight consumers in their enjoyment of the product (e.g., freshness scent) and/or aid in perception of product performance (e.g., cleaning power). As a result, fragrances often serve as a key element to help drive sales of a given consumer product. Moreover, consumers are becoming more demanding of the fragrance performance in the products. For instance, some consumers seek products that can deliver intense fragrance profile onto a substrate (e.g., fabric, hard surface, skin), particularly from those characters attributable to the high volatile fragrance materials (i.e., top notes). While other consumers are seeking more sustainable and/or biodegradable products having minimal environmental impact, yet without any or minimal trade-offs on fragrance performance and/or sensorial benefits.

Most dry/anhydrous applications, including scent boosters, comprise solid particles which can act as a carrier of fragrance materials, and are commonly produced using a hot melt pastillation process as the preferred delivery system. As the name suggests, scent boosters, are used to provide an intense scent to the laundry. They are added during the washing cycle, in addition to laundry detergents and/or fabric conditioners/enhancers and are intended to be deposited onto laundered clothes for release of the fragrance materials at later touchpoints. With the current hot melt process technology, the fragrance component is typically incorporated at relatively low levels (i.e., 10% or less) while the other 90% or greater is a carrier that contains materials commonly derived from petrochemicals (e.g., polyethylene glycol). As one can imagine, there are several drawbacks to this approach. Firstly, there is increased cost of production, packaging and/or transportation of these scented particles on account of their low fragrance loading. Secondly, there is a large carbon footprint associated with these scent particles because they carry a disproportionately small amount of fragrance materials to give the intended fragrance benefits to the consumer. Thirdly they are not particularly water soluble/dispersible often taking greater than the length of the initial wash cycle to properly dissolve/disperse. This can leave residues on clothing especially at lower temperature wash cycle that are becoming more popular as detergents allow low temp washing and energy costs and environmental awareness grows.

Spray dry powders can have a high fragrance load. However, they are a fine powder that makes them difficult to pour or handle, they are dusty and they can as well as being a respiratory hazard they can be an explosion hazard with low ignition energy requirements once airborne. This makes spray dry powders unsuitable as a consumer product for scent booster applications and is the reason this very familiar technology hasn't been commercialized for such purposes.

### BRIEF SUMMARY OF THE DISCLOSURE

The granules of the present disclosure is based, inter alia, on the discovery of new fragrance-containing granules that have specific combinations of parameters that allow them to deliver certain benefits, including for non-limiting examples, high fragrance loading, sustainability associated with a low carbon footprint, and/or improved fragrance profile, especially character intensity derived from high volatile fragrance materials (i.e., top notes).

In a first aspect, the present disclosure provides a fragrance-containing granule comprising (a) a fragrance material comprising a neat fragrance and an encapsulated fragrance; and (b) a carbohydrate carrier; wherein the amount of the fragrance material is greater than 40 wt %, 45 wt %, 50 wt %, 55 wt %, or 60 wt %, based on the weight of the granule; the weight ratio of the neat fragrance to the encapsulated fragrance is from 10:1 to 1:1; and the granule has a skeletal density of greater than 1.00 g/mL or 1.05 g/mL.

In another aspect, the present disclosure provides a process for treating laundry comprising the step of dosing to a laundry load in a washing machine or in a wash basin from 1 g to 30 g, preferably from 3 g to 20 g of the granules of the present disclosure.

In yet another aspect, the present disclosure provides a consumer product comprising the granules of the present disclosure, preferably the consumer product is a scent booster, a fabric refresher, a detergent (powdered), a fabric softener, a rinse-aid, a water-softening agent, a bleach-booster, a sanitizing agent, a unit dose laundry detergent, a powdered, a detergent granule, a detergent tablet, a laundry sachet or a cleaning composition.

It is an advantage of the present disclosure to provide new fragrance-containing granules that can provide one or more performance and/or sensorial benefits. In particular, it is an advantage that the granules of the present disclosure have a larger size (1-5 mm) than traditional spray-dried particles (about 50 microns). The larger sized granules according to the present disclosure have multiple benefits. Firstly, the larger size allows for a more controlled release of the fragrance materials (neat and/or encapsulated) during the wash cycle leading to a more even distribution of the fragrances on the laundered clothes. Secondly, the larger size granules are easier to handle, produce less dust during handling and/or represent a reduce explosive risk. Thirdly, the larger size also provides less surface area for the fragrance materials to diffuse out during storage, causing an improvement in the fragrance quality retention over time.

It is yet a further advantage of the present disclosure to provide granules that have a high fragrance pay-load. Sampling of current market PEG (polyethylene glycol) based scent booster particles (e.g., P&G Unstopables®) indicates a fragrance load upper limit of about 12% by weight of the particles. This low maximum load is due to the low melting point of PEG based particles and the resultant consumer product (i.e., ˜59° C.). If more fragrance materials or other additives are added then the melting point of the PEG based scent particles become too low (i.e, lower than 59° C.) for the consumer product to be reasonably transported, particularly during summer months where transport temperatures can easily exceed 60° C. or 70° C.

In contrast, the fragrance-containing granules of the present disclosures are formed from biobased material(s) that have a higher melting point, preferably higher than 60° C., 70° C., 80° C., 90° C. or 100° C. This means that the fragrance-containing granules of the present disclosure can have additional fragrance materials and/or other actives, without compromising the melting point of the granules. Accordingly, the granules of the present disclosure can have high fragrance load whilst remaining physically stable for transport at temperatures above 60° C., 80° C. or 100° C.

All parts, percentages and proportions referred to herein and in the claims are by weight unless otherwise indicated.

The values and dimensions disclosed herein are not to be understood as being strictly limited to the exact numerical values recited. Instead, unless otherwise specified, each such value is intended to mean both the recited value and a functionally equivalent range surrounding that value. For example, a value disclosed as “50%” is intended to mean “about 50%”.

### BRIEF DESCRIPTION OF THE DRAWING

Embodiments are illustrated in the accompanying FIGURE to improve understanding of concepts as presented herein.

FIG. 1 shows the process scheme for manufacturing an embodiment of the fragrance-containing granule of the present disclosure.

### DETAILED DESCRIPTION

The foregoing general description and the following detailed description are exemplary and explanatory only and are not restrictive of the invention, as defined in the appended claims. Other features and benefits of any one or more of the embodiments will be apparent from the following detailed description, and from the claims.

As used herein, the terms “comprises”, “comprising”, “includes”, “including”, “has”, “having”, “contains”, “containing” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of embodiments of the present invention, suitable methods and materials are described below. In addition, the materials, methods, and examples are illustrative only and not intended to be limiting.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. For example, when a range of “1 to 10” is recited, the recited range should be construed as including ranges “1 to 8”, “3 to 10”, “2 to 7”, “1.5 to 6”, “3.4 to 7.8”, “1 to 2 and 7-10”, “2 to 4 and 6 to 9”, “1 to 3.6 and 7.2 to 8.9”, “1-5 and 10”, “2 and 8 to 10”, “1.5-4 and 8”, and the like.

The present disclosure illustratively described herein suitably may be practiced in the absence of any element or elements, limitation or limitations that are not specifically disclosed herein. While compositions and methods are described herein in terms of “comprising” various components or steps, the compositions and methods also can “consist essentially of” or “consist of” the various components or steps, unless stated otherwise.

Before addressing details of embodiments described below, some terms are defined or clarified.

The term “wt %”, as used herein, means percentage by weight.

As used herein, the term “average granular weight” means the value calculated by taking the total weight of 3000 granules (in mg), which is then divided by 3000 to obtain an approximate weight of each granule in mg.

As used herein, the term “Average Mean Diameter” means the value calculated by using an image analysis software (e.g., ImageJ Image Analysis Software, Ver. 1.530 (January 2022) available from NIH; MIPAR Image Analysis Software, Ver. 3.4, available from MIPAR Image Analysis (Columbus, Ohio); or Pax-It Image Management System, Ver. 1.3, available from Pax-It!™). A digital photo is taken of the granules using a size reference in the photo. Then the image analysis software measures the diameter of the granules (e.g., several hundreds). It then calculates the Average Mean Diameter along with the standard deviation.

The terms “obtainable” and “obtained” can be used interchangeably in this disclosure and do not mean to indicate that, e.g., a product must be obtained by, e.g., the sequence of steps following the term “obtained” though such a limited understanding is always included by the terms as a preferred aspect of the present disclosure.

As used herein, the term “biobased” refers to atoms or molecules obtained from biomass, e.g., obtained from materials containing organic carbon of renewable origin. Sources of such carbon can be derived from agricultural products, plants, animals, fungi, microorganisms, marine, or forestry materials.

The term “biodegradable” as used herein with respect to a material, such as microcapsule shell and/or fragrance, means that the material has no real or perceived health and/or environmental issues, and can undergo and/or does undergo physical, chemical, thermal, microbial and/or biological degradation. Ideally, a microcapsule shell and/or fragrance is deemed “biodegradable” when the microcapsule shell and/or fragrance passes one or more of the following tests including: a respirometry biodegradation method in aquatic media, available from Organization for Economic Cooperation and Development (OECD), International Organization for Standardization (ISO) and the American Society for Testing and Material (ASTM) tests including, but not limited to OECD 301F or 310 (Ready biodegradation), OECD 302 (inherent biodegradation), ISO 17556 (solid stimulation studies), ISO 14851 (fresh water stimulation studies), ISO 18830 (marine sediment stimulation studies), OECD 307 (soil stimulation studies), OECD 308 (sediment stimulation studies), and OECD 309 (water stimulation studies). Preferably, the microcapsule shell and/or fragrance is readily biodegradable as determined using a respirometry biodegradation method in aquatic media, the OECD 301F or OECD 310 test. More preferably, the microcapsule shell and/or fragrance is biodegradable if the shell and/or fragrance has a biodegradation rate of at least 20%, 30%, 40%, 50%, 60%, 65%, 70%, 75%, 80%, 85%, 90%, 95% or 98%, based on the weight of the shell and/or fragrance, within 60 days according to the OECD301F or OECD310 tests, or most preferably a biodegradability of at least 60% within 60 days according to OECD301F test.

As used herein, the term “bulk density” means the mass of the many fragrance-containing granules divided by the total volume they occupy. The total volume includes granule volume, inter-granule void volume and intra-granule void volume. Bulk density differs from skeletal density in that it includes both intra and inter granule voids. Bulk density is determined by measuring the volume of 100 g of granules in a 250 mL graduated cylinder after compaction by standardized tapping. The tapped bulk density is calculated by dividing mass (100 g) by the volume.

As used herein, the term “consumer” means both the user of the composition and the observer nearby or around the user.

The terms “fragrance components”, “fragrance materials” and “fragrance ingredients” are used interchangeably, and refer to a composition of fragrance compounds for the purpose of delivering a specific and/or pleasant fragrance profile to drive consumer delight or acceptance of the consumer product and/or fragrance composition. “Fragrance material(s)” mean a perfume raw material (“PRM”), or a mixture of perfume raw materials (“PRMs”), that are used to impart an overall pleasant odor or fragrance profile to a composition. “Fragrance materials” can encompass any suitable perfume raw materials for fragrance uses, including materials such as, for example, alcohols, aldehydes, ketones, esters, ethers, acetates, nitriles, terpene hydrocarbons, nitrogenous or sulfurous heterocyclic compounds and essential oils. However, naturally occurring plant and animal oils and exudates comprising complex mixtures of various chemical components are also known for use as “fragrance materials”. The individual perfume raw materials which comprise a known natural oil can be found by reference to Journals commonly used by those skilled in the art such as “Perfume and Flavourist” or “Journal of Essential Oil Research”, or listed in reference texts such as the book by S. Arctander, Perfume and Flavor Chemicals, 1969, Montclair, New Jersey, USA and more recently re-published by Allured Publishing Corporation Illinois (1994). Additionally, some perfume raw materials are supplied by the fragrance houses (Firmenich, International Flavors & Fragrances, Givaudan, Symrise) as mixtures in the form of proprietary specialty accords.

As used herein, the term “fragrance profile” means the description of how the fragrance is perceived by the human nose at any moment in time. The fragrance profile may change over time. It is a result of the combination of the base, heart and top notes, if present, of a fragrance. Base notes are characterized by providing animalic, woody, sweet, amber or musky characters, and not being very volatile. Heart notes are associated with desirable characters such as floral characters (e.g., jasmin, rose), fruity, marine, aromatic or spicy characters. The “top or head notes” provide citrusy, green, light, or fresh characters and tend to evaporate quickly due to their high volatility. A fragrance profile is composed of 2 characteristics: “intensity” and “character”. The “intensity” relates to the perceived strength whilst “character” refers to the odor impression or quality of the perfume, i.e., fresh, clean, etc.

As used herein, the term “granule” refers to a particle which contains a core (typically a small core particle) and an active agent (typically a fragrance). The term “granule” may also refer to fibers, flakes, spheres, powders, platelets and other shapes and forms.

As used herein, the terms “particle size dispersity index (PSDI)” and “polydispersity index” are used interchangeably and mean the distribution of size populations within a granule sample. In this disclosure, the particle size dispersity index (PSDI) is calculated as the standard deviation divided by the mean granule diameter.

As used herein, the term “substantially free” in reference to a material means that the indicated material is present in an amount of from 0 wt % to about 1 wt %, preferably from 0 wt % to about 0.5 wt %, or more preferably from 0 wt % to 0.2 wt %. The term “essentially free” means that the indicated material is present in an amount of from 0 wt % to about 0.1 wt %, preferably from 0 wt % to about 0.01 wt %, or more preferably it is not present at analytically detectable levels.

As used herein, the term “skeletal density” is the ratio of the mass of solid material contained in a granule to the sum of the volumes of the solid material and closed (or blind) pores within the granule. Skeletal density in this disclosure is determined by the method as described in the Skeletal Density Test.

The term “water activity (a_{w})”, as used herein with respect to a substance (e.g., granule), means the partial vapor pressure of water in the substance at a given temperature divided by the partial vapor pressure of pure water at the same temperature.

As used herein, the terms “g,” “mg,” and “μg” refer to “gram,” “milligram,” and “microgram,” respectively. The terms “L” and “mL” refer to “liter” and “milliliter,” respectively.

It is understood that the test methods that are disclosed in the Test Methods Section of the present application must be used to determine the respective values of the parameters of Applicants' inventions as described and claimed herein.

### Fragrance-Containing Granules

WO2016/205587A1 (Procter & Gamble) discloses perfumed particles made from a hot melt pastillation system using oil-derived PEG (polyethylene glycol) base to form hemi-sphere granules. These particles have low fragrance loading (≤20% by weight of said particles of encapsulated fragrances). The particles also have closed occlusions of gas (i.e., entrapped air) added during the forming process resulting in particles having a density of <0.95 g/cm³, which causes the particles to float in a wash liquor and release fragrances directly into the head-space above the wash liquor during use. WO2018/172514 (Firmenich) discloses a solid scent booster composition comprising a solid carrier (e.g., sodium chloride, sodium acetate, urea, clay, PEG or mixtures thereof) and a granulated powder comprising particles having a low fragrance load (≤ 30% by weight of the encapsulated fragrance oils). WO2006/056093 A1 (Givaudan SA) teaches how to make high fragrance load >80%, water soluble granules using hydroxy propyl methyl cellulose (HPMC). However, it only uses microencapsulated fragrance as adding any meaningful level of neat fragrance oil to HPMC creates a non-granular, non-uniform mess that cannot be used as a consumer product. The granule made from HPMC and fragranced microcapsules is used to dose microcapsules into powdered or granular consumer products such as laundry detergent powders. This granule is not suitable for a scent booster type application as it cannot contain enough neat oil to impart consumer acceptable levels of fragrance on damp laundry being taken from the washing machine. Microcapsules are added to deposit fragrance on cloth and delay the release to when the clothing is dry.

There are several drawbacks. Firstly, the disclosed scented particles have low fragrance loading and/or cannot carry much in the way of additional actives. That means those products require relatively large volumes of packaging, store shelf-space and/or higher transportation costs. Secondly, the disclosed scented particles are made from non-environmentally friendly materials for the carriers. This is a problem as consumers and/or regulators are demanding/requiring sustainable products that can be more renewably sourced. Thirdly, these approaches do not teach how to improve the fragrance profile, more specifically how to selectively increase and/or extend the intensity of the more desirable characters attributable from the high volatile fragrance materials (i.e., top notes). Lastly, the intended fragrance release based on scented granules disclosed in WO2016/205587A1 occurs during exposure to the wash liquor while laundering clothes, which is not the desired touch point for delivering a scent for a scent booster product, which is while the consumer is wearing the laundered clothes.

As such existing solutions still have limitations, and do not adequately teach how to overcome these problems. Accordingly, there is still a need for the development of new scented granules having high load of fragrance materials. There is also a need for these scented granules to be sustainable and are more renewably sourced and/or have greatly reduced transport, packaging and/or carbon usage. It is also desirable that the scented granules are useful to improve intensity of the fragrance profile, particularly fragrances derived from high volatile fragrance materials (i.e., top notes).

Inventors have surprisingly discovered new fragrance-containing granules that have specific combinations of parameters that allow them to deliver certain benefits, including for non-limiting examples, high fragrance loading, sustainability associated with a low carbon footprint, and/or improved fragrance profile, especially character intensity derived from high volatile fragrance materials (i.e., top notes). As used herein, the term “high volatile fragrance material” refers to fragrance materials that have a vapor pressure greater than 0.1 Torr (0.0133 kPa) at 25° C. (i.e., top notes). Vapor pressure is determined in accordance with Test Method 1 (Determining Vapor Pressure) of WO2016/200761A1, the content of which is incorporated herein by reference.

Specifically, in one aspect, the present disclosure provides a fragrance-containing granule comprising (a) a fragrance material comprising a neat fragrance and an encapsulated fragrance; and (b) a carbohydrate carrier; wherein the amount of the fragrance material is greater than 40 wt %, 45 wt %, 50 wt %, 55 wt %, 60 wt %, 70 wt %, 80 wt %, or 90 wt %, based on the weight of the granule; the weight ratio of the neat fragrance to the encapsulated fragrance is from 10:1 to 1:1; and the granule has a skeletal density of greater than 1.00 g/mL, 1.05 g/mL, 1.10 g/mL, or 1.15 g/mL, preferably greater than 1.00 g/mL. Preferably the fragrance material is present in an amount of greater than 40 wt %, 45 wt %, 50 wt %, 55 wt %, or 60 wt % based on the weight of the granule.

Unlike other scented particles which are designed to float in liquid to provide the benefit of enhanced perfume bloom during the wash cycle (see WO2016/205587A1), the fragrance-containing granules of the present disclosure generally do not float in the wash liquor or do not float for any appreciable amount of time in the wash liquor. Instead, the granules of the present disclosure tend to dissolve relatively fast once added to the wash liquor to release the fragrance materials and other beneficial constituents, if present. Preferably, the granule of the present disclosure is characterized by a dissolution rate of no more than about 5 minutes, 4 minutes, 3 minutes, 2 minutes, 1 minute, or 30 seconds, as measured in deionized water at 25° C. using the Dissolution Rate Test described in this disclosure. In some embodiments, the dissolution rate is from about 30 seconds to 1 minute, from about 1 minute to 5 minutes, from about 30 seconds to 3 minutes, or from about 30 seconds to 2 minutes. In some embodiments, the dissolution rate is no more than about 1 minute.

By having a fast dissolution rate, the fragrance-containing granule will dissolve in the wash liquor to release the fragrance materials and other beneficial constituents, if present. In some embodiments, a majority or substantially all of the fragrance-containing granules will dissolve in the wash liquor between 1 to 5 minutes, preferably less than about 1 minute, upon their addition to the wash liquor. It is believed that successful incorporation of fragrance-containing granules into particulate laundry detergent products requires fast dissolution in water at about 25° C. within about 5 minutes, preferably within about 1 minute. This fast dissolution rate has an additional benefit over the PEG based scent booster in that they will dissolve in the fabric conditioner dispenser in an automatic washing machine allowing less product to be added for the same or higher level of fragrance performance from the dry clothing. This is due to the fabric conditioner dispenser dispensing in the last rinse of the wash cycle meaning very little of the fragrance or fragranced microcapsules are rinsed to the drain which unfortunately happens to more than half of the fragrance added when scent boosters are added at the beginning of the wash cycle where the machine's program can include 3 or 4 rinse cycles, (a minimum of 2 rinse cycles).

As used herein, the term “particulate laundry detergent” refers to a solid powder or granular laundry detergent composition such as an all-purpose or heavy-duty washing agent for fabrics. The particulate laundry detergent is preferably free-flowing powdery or granular detergent composition. In other words, the fragrance-containing granules will need to dissolve or disperse or disintegrate in water at the same or similar speed as the base particles of such particulate laundry detergent products. Therefore, the fragrance-containing granule of the present disclosure having the fast dissolution rate is suitable for incorporation into such particulate laundry detergent products, otherwise, they could adversely affect the overall consumer perception and acceptance of the particulate laundry detergent products.

Furthermore, consumers typically do not like the appearance of any undissolved fragrance-containing granules during the washing process and are inclined to view their presence as an indicator of poor and/or unacceptable performance of such products. In fact, such undissolved fragrance-containing granules can result in residues being deposited on the fabrics during washing and can be viewed by the consumers as a disadvantage of the products. As used herein, the term “residue” means the mass of material from the granules that is retained on the fabric or material after use. In some embodiments, the fragrance-containing granule of the present disclosure has a dispersion profile having less than 5%, or less than 2%, or less than 1% residue associated with the granule.

Essentially the solution is to print granules using primarily water-soluble or water-dispersible biobased materials combined with fragrance oils to make an oil-in-water emulsion that is deposited as “dots” or “droplets” on a belt. The droplets are then dried to remove all or substantially all of the water to form the new fragrance-containing granules. According to some embodiments, the granules of the present disclosure are formed from droplets obtainable from a deposition process comprising depositing a semi-viscous slurry onto a belt. In a particular embodiment, the slurry has a viscosity of from 1,000 m·Pas to 20,000 m·Pas, preferably from 2,000 m·Pas to 10,000 m·Pas, at room temperature. Without wishing to be bound by theory, it is important for the granules to be formed from a semi-viscous slurry because too much water will result in a low viscosity slurry that would fail to deposit as discrete “dots” or “droplets” on the belt. However, too little water will result in a high viscosity slurry that would be difficult to pump and deposit onto the belt. Applicant has found a sweet spot in terms of viscosity ranges so that the slurry is formulated with as little water as possible, yet still functional for the print process, to contains less water to evaporate and hence allowing these particles to be more efficient and/or more sustainable.

In some embodiments, the fragrance-containing granule of the present disclosure comprises a plurality of intra-granule air voids (i.e., air voids within the granule) formed from the heating of the granule to evaporate the water. Preferably, the granule comprises less than 20%, 15%, 10%, 5% or 1% water, based on the weight of the granule. In some embodiments, the granule is essentially free of water. As used herein, the term “air voids” refer to void spaces inside the granule in a porous or hollow form that are continuously kept after the granules are formed, preferably without being filled with other impurities. As the name suggest, air voids are filled with air and not other gases. The granule of the present disclosure has air voids that may have asymmetrical or irregular shapes having curved contours, or spherical or irregular spherical shapes (e.g., ellipses, crescents and the like). No observable difference in key performance criteria (e.g., dissolution rate and the like) is expected between spherical air voids over non-spherical air voids. Therefore, in certain embodiments of the present disclosure, the “air avoids” may comprise a combination of spherical and non-spherical air avoids.

The air voids may have varying dimensions, for non-limiting example, anywhere between about 1 micron to about 3000 microns, for example when measured longitudinally. Without wishing to be bound by theory, it is believed that smaller air avoids (e.g., less than about 1000, 500, 400, 300, 200 or 100 microns or any units therein between) may merge with other air avoids forming larger air avoids during the drying process. The resultant larger air voids (e.g., ≥100 microns, ≥200 microns, ≥300 microns, ≥400 microns, ≥500 microns, ≥600 microns, ≥700 microns, ≥800 microns, ≥900 microns or ≥1000 microns) are more desirable than smaller air voids to promote dissolution rate. Alternatively, the air voids of the present disclosure may comprise any combination of smaller and larger air voids, so long as they result in granules having the desired dissolution rate as described herein. In some embodiments, the fragrance-containing granule of the present disclosure comprises a plurality of intra-granule air voids having longitudinal dimension of at least 1 micron, at least 10 microns, at least 50 microns, at least 100 microns, at least 200 microns, at least 300 microns, at least 400 microns, or at least 500 microns. In some embodiments, the fragrance-containing granule of the present disclosure comprises a plurality of intra-granule air voids having longitudinal dimension of no more than 3000 microns, no more than 2500 microns, no more than 2000 microns, or no more than 1500 microns.

In some embodiments, the total volume of the air voids within the fragrance-containing granule (i.e., intra-granule air voids) is at least 10%, at least 15%, at least 20%, at least 25%, or at least 30%, based on the volume of the granule. In some embodiments, the total volume of the air voids within the granule is no more than 70%, no more than 65%, no more than 60%, no more than 55%, or no more than 50%, based on the volume of the granule. In some embodiments, the total volume of the air voids within the granule is in the range of from 15% to 70%, from 20% to 60%, or from 35% to 55%, based on the volume of the granule. Without being bound by theory, it is believed that air voids within the granule can increase the dissolution rate of the granule during its use in the washing cycle.

It is important to note that no air or other gas is intentionally added to the precursor materials in any steps used to make the air avoids enclosed in fragrance-containing granules of the present disclosure. Furthermore, as described above, the air voids found in the fragrance-containing granules are formed from water evaporation during the heating step, and not as a result of any fracturing during cooling step of the precursor materials from which the granules are produced. The combination of these different factors give rise to granules of the present disclosures having air voids that have notable different characteristics over any scented particles presently known.

In some embodiments, the carbohydrate carrier is water-soluble or water-dispersible. In some embodiments, the carbohydrate carrier has a melting point temperature of at least 70° C., at least 80° C., at least 90° C., or at least 100° C. The fragrance load of the current benchmark PEG based granules is limited to a maximum of 12% by weight of the granules. The melting point temperature of PEG is approximately 60° C.-62° C. Due to its low melting temperature, if more fragrance materials, or other additives, are added to the PEG based granules, the melting point temperature of the granules will become too low for transport since temperatures can often exceed 60° C. Thus, there is limited formulation flexibility with the PEG based granules. In contrast, the fragrance-containing granule of the present disclosure is made from carbohydrate carriers that have a higher melting point temperature, so more fragrance materials, or other additives, can be added whilst still maintaining suitability for transport (and storage) at high temperatures (e.g., >80° C., >90° C. or >100° C.).

In some embodiments, the fragrance-containing granule of the present disclosure has an Average Mean Diameter in the range of 1 mm to 20 mm, or 1 mm to 15 mm, or 1 mm to 10 mm, or 1 mm to 5 mm, or 2 mm to 3 mm. In some embodiments, the granule has an Average Mean Diameter of at least 0.5 mm, at least 1 mm, at least 1.5 mm, or at least 2 mm. In some embodiments, the granule has an Average Mean Diameter of no more than 20 mm, no more than 18 mm, no more than 15 mm, no more than 12 mm, no more than 10 mm, no more than 8 mm, no more than 5 mm, or no more than 3 mm. The Average Mean Diameter of the granules may be determined by measuring the diameter distribution of the granules using image analysis software as described in this disclosure.

In some embodiments, the fragrance-containing granule of the present disclosure is characterized by the following features:
(i) a water activity (a_{w}) of less than 0.6 at 25° C.; and/or
(ii) an average granular weight of 1 mg to 10 mg, or 3 mg to 7 mg; and/or
(iii) a bulk density of 0.1 g/mL to 1 g/mL, or 0.2 g/mL to 0.6 g/mL.

In some embodiments, the fragrance-containing granule has all the three features as recited above. Fragrance-containing granules with the above-described water activity (a_{w}), average granular weight and bulk density can provide a significant improvement over existing scent particles. Without wishing to be bound by theory, the fragrance-containing granules with these features are dry free flowing, high fragrance loading powder/granules that offer protection from air and evaporation, long-lasting performance in a convenient and safe manner that avoids unintended ignition of fragrance vapor.

In some embodiments, the fragrance-containing granule of the present disclosure has a particle size dispersity index (PSDI) of less than 0.2 (St. Dev/Mean). PSDI can be measured with Malvern Nano-S, and further details of the method is described in <https://www.ncbi.nlm.nih.gov/pmc/articles/PMC5035303/>, the content of which is incorporated herein by reference. It is yet a further advantage that the granules of the present disclosure exhibit a polydispersity index of less than 0.2 (St. Dev/Mean). This means that the granules of the present disclosure have a more monodispersed particle size distribution than traditional spray-dried particles, which tends to have a polydispersed particle size distribution. Without wishing to be bound by theory, it is believed that granules having more monodispersed particle size distribution, plus the capability to modulate particle size, will result in a more favorable uniform distribution of the granules when blended with other dry products. As a result, during use the fragrance-containing granules of the present disclosure will exhibit a more even distribution on the laundered clothing.

In some embodiments, the fragrance-containing granule of the present disclosure has a weight ratio of the fragrance material to the carbohydrate carrier of from about 9:1 to about 1:1.5, or from about 9:1 to about 1:1. In other words, the granule of the present disclosure has high fragrance load. In particular embodiments, the consumer products (e.g., scent boosters) formulated with the granule of the present disclosure have a weight ratio of fragrance material to carbohydrate carrier of 50/50, which is considerably higher than current level of fragrance material to carrier of 10/90 of the current benchmark PEG based scent boosters. In fact, the granules of the present disclosure offer a scent booster product that can be dosed to a washing machine (or wash basin) at a fifth of the current dosages while delivering parity and/or improved fragrance profile benefits. Additionally, this high fragrance loading property of the granule will greatly reduce the packaging size (e.g., less plastic or cardboard), require significantly less storage and warehouse space, and/or minimize the transport cost and associated carbon footprint.

Another aspect of the present disclosure is the desire to move towards the use of granules, and/or their components (e.g., fragrance ingredients, microcapsules and the like) derived from “Green Chemistry” principles. Green Chemistry is focused on the design of products and processes that minimize environmental impact, particularly by using renewable feedstocks, repurposed and/or upcycled carbon resources that can be replenished to replace the portion depleted by usage and/or consumption, either through natural reproduction, or other recurring processes in a finite amount of time (such as within a human lifetime). In other words, the raw material or feedstock used to make the granules and/or their components should be renewable, repurposed and/or upcycled carbon resources rather than depleting whenever technically and economically practicable. As used herein, “BRC” refers to carbon that is part of the earth's natural environment and non-fossil-based carbon. BRC are naturally occurring renewable, repurposed and/or upcycled carbon resources that can be replenished to replace the portion depleted by usage and consumption, either through natural reproduction, or other recurring processes in a finite amount of time (such as within a human lifetime). BRC would exclude carbon that comes from virgin crude oil. In some embodiments, the fragrance-containing granule of the present disclosure has a bio-renewable carbon (BRC) content of at least 25%, at least 30%, at least 35%, at least 40%, at least 45%, at least 50%, at least 55%, at least 60%, at least 65%, at least 70%, at least 75%, at least 80%, at least 85%, at least 90%, or at least 95%, based on the weight of the granule.

In some embodiments, the fragrance-containing granules may be formed into spheres, hemispheres and the like. The granule can have any shape selected from the group consisting of spherical, hemispherical, compressed hemispherical, disc, circular, lentil-shaped, oblong, and combinations thereof, preferably hemispherical or compressed hemispherical. As used herein, “lentil-shaped” refers to the shape of a lentil bean, and “compressed hemispherical” refers to a shape corresponding to a hemisphere that is at least partially or substantially flattened such that the curvature surface is less, on average, than the curvature of a hemisphere having the same radius. A compressed hemispherical particle can have an aspect ratio (i.e., the ratio of its base diameter over its height that is orthogonal to the base) of from about 2.0 to about 5, alternatively form about 2.1 to about 4.5, alternatively from about 2.2 to about 4. “Oblong-shaped” granule refers to a particle having a maximum dimension and a secondary dimension orthogonal to the maximum dimension, wherein the ratio of maximum dimension to the secondary dimension is greater than about 1.2, preferably greater than about 1.5, more preferably greater than about 2. Additionally, the granule of the present disclosure may have been ruptured and deformed during the drying step of the production process. As a result, the granules may have an irregular shaped hemispheres or compressed hemispheres.

In some embodiments, fragrance-containing granules of the present disclosure can have different shapes, sizes, and/or skeletal density. In some embodiments, the fragrance-containing granules are added as a component in other products. For example, the granules may be added to a powdered laundry detergent. Given that the fragrance-containing granules are differently shaped and/or sized from the detergent particles, it is likely that they will segregate from the detergent particles during transport and storage. Such segregation may lead to significant variations in the amount of the fragrance-containing granules in the particulate laundry detergent composition from dosage to dosage. It has been discovered that such hemispherical or compressed hemispherical shape helps to significantly reduce segregation of the fragrance-containing granules in the powder laundry detergent composition, e.g., by at least 20%, 30%, 40%, 50%, 60%, 70%, or 80%, in comparison with fragrance-containing granules having other shapes.

### Fragrances

As used herein, the term “neat fragrance” means a fragrance component that is free from extraneous matter and is unencapsulated and/or unbound from other compounds that would cause a delay in the release of the fragrance component. In some embodiments, the fragrance material comprises a neat fragrance, and the neat fragrance is present in an amount of >30 wt %, >40 wt %, >50 wt %, >60 wt %, >70 wt %, >80 wt % or >90 wt %, based on the total weight of the granule. In some embodiments, the granule of the present disclosure comprises neat fragrance in an amount of from 30 wt % to 45 wt %, or from 25 wt % to 42.5 wt %, based on the total weight of the granule.

As used herein, the term “encapsulated fragrance” means a fragrance component which is encapsulated in a microcapsule (in order to stabilize the odor impression over a prolonged period). Microcapsules are used to deliver fragrances to a target area in a time-delayed or controlled manner. In some embodiments, the microcapsule has an average particle size of from 1 and 100 microns, preferably from 1 to 50 microns or more preferably from 1 to 20 microns. The microcapsules may be prepared from natural materials like fungal chitosan (WO2016/185171A1), silk fibroin particles (US2015/0164117A1), and biomolecules used as emulsifiers in microcapsule preparation (WO2016/193435A1, WO2017/102812A1, US2018/0078468A1, WO2018/019894A1, WO2018/019896A1 and WO2017/102812A1). Microcapsules comprising multilayered coacervate between gelatin and gum Arabic may be used in the present disclosure (U.S. Pat. No. 4,946,624, WO2012/001604A1, US2015/0250689A1 and WO2018/002214A1). Protein microcapsules are also useful within the scope of the present disclosure (US2017/0189283A1). In some embodiments, environmentally friendly microcapsules where the shell has a biodegradability of at least 60% within 60 days according to OECD 301F are also within the scope of the present disclosure (WO2021/122633A1).

In some embodiments, the encapsulated fragrance is encapsulated by a biodegradable microcapsule shell. Preferably, the biodegradable microcapsule shell has a biodegradation rate of at least 20%, at least 30%, at least 40%, at least 50%, at least 60%, at least 65%, at least 70%, at least 75%, at least 80%, at least 85%, at least 90%, least 95%, or at least 98%, based on the weight of the microcapsule shell, within 60 days according to OECD301F or OECD310, preferably at least 60%, based on the weight of the microcapsule shell, within 60 days according to OECD301F. As used herein, the terms “wall” and “shell” are used interchangeably to denote the structure formed by the microencapsulating polymer surrounding the active material (e.g., fragrance) core being microencapsulated.

Other suitable non-limiting examples of microcapsules within the scope of the present disclosure include:
(i) microcapsules with a biodegradable microcapsule shell comprising at least one biobased epoxide selected from diglycidyl ether diphenolic ester, preferably the biobased epoxide is selected from diglycidyl ether diphenolic methyl ester; diglycidyl ether diphenolic ethyl ester; diglycidyl ether diphenolic butyl ester; diglycidyl ether diphenolic pentyl ester; or diglycidyl ether diphenolic methoxy PEG, wherein the PEG is any one of PEG1 to PEG10, preferably diglycidyl ether diphenolic methoxy PEG1, wherein the biobased epoxide is polymerized by interfacial polymerization with a polyamine selected from hexamethylene diamine (HMDA), ethylene diamine (EDA), diethylene triamine (DETA), dipropylenetriamine (norspermidine), triethylene tetramine (TETA), tetraethylene pentamine (TEPA), chitosan oligosaccharide (COS), guanidine carbonate, a polylysine or lysine containing protein, gelatin or a combination thereof; and/or
(ii) microcapsules with a biodegradable microcapsule shell comprising an isocyanate-biodegradable polymer shell comprising the reaction product of a biodegradable, isocyanate-terminated prepolymer with a crosslinker and optionally a polyelectrolyte emulsifier under aqueous conditions, wherein the biodegradable, isocyanate-terminated prepolymer comprises gelatin, collagen, chitosan, modified guar, modified glucan, gum Arabic (gum acacia), modified gum Arabic (modified gum acacia), protein, hydrolyzed proteins, fermented proteins, hydrophobin, enzymes, partially neutralized citric acid ester, alginate, carrageenan, pectin, modified starch, or modified cellulose, and the crosslinker comprises an oxidized sugar (EP 21198609.6); and/or
(iii) microcapsules with a biodegradable microcapsule shell comprising chitosan cross-linked with a polyfunctional isocyanate having at least two isocyanate functional groups and a tannic acid, wherein the tannic acid is hydrolyzed tannic acid, unhydrolyzed tannic acid, or a combination thereof, wherein the shell further comprises carrageenan, gum Arabic (gum acacia), or a combination thereof and the polyfunctional isocyanate is a biuret, isocyanurate, allophanate, uretdione, oligomeric hexamethylene diisocyanate, or a combination thereof (EP 22150553.0); and/or
(iv) microcapsules with a biodegradable microcapsule shell comprising the reaction product of a biodegradable, isocyanate-terminated prepolymer with a crosslinker and optionally a polyelectrolyte emulsifier under aqueous conditions (EP 22151570.3); and/or
(v) microcapsules with a biodegradable microcapsule shell comprising a trimethylol propane-adduct of xylylene diisocyanate, a dispersant comprising denatured pea protein and a hydrocolloid comprising gum Arabic; and/or
(vi) microcapsules with a biodegradable microcapsule shell comprising a biopolymer cross-linked with one or more cross-linking agents, wherein the biopolymer is a whey protein or a denatured whey protein.

In some embodiments, the materials used to form the wall of biodegradable microcapsules of the present disclosure preferably do not form a blend of biodegradable materials and non-biodegradable materials. In some embodiments, the materials used to form the wall of the microcapsules form a blend of biodegradable materials and non-biodegradable materials, wherein the levels of the non-biodegradable materials are below 10%, below 5%, below 3%, below 1% or below 0.5%, relative to weight of the microcapsules. In some embodiments, the materials used to form the wall of the microcapsules forms a blend of biodegradable materials and non-biodegradable materials, wherein the biodegradation rate of all components of the blend is at least 20%, 30%, 40%, 50%, 60%, 65%, 70%, 75%, 80%, 85%, 90%, 95% or 98%, based on the total weight of the blend, within 60 days according to OECD301F or OECD310.

In some embodiments, the fragrance material comprises an encapsulated fragrance, and the encapsulated fragrance is present in an amount of >5%, >10%, >15%, >20%, >25%, or >30%, based on the total weight of the granule. In some embodiments, when including encapsulated fragrance at these levels, the neat oil equivalent (NOE) in a solid form fabric conditioner (comprising the granule of the present disclosure) is 1 to 10%. In some embodiments, the granule of the present disclosure comprises encapsulated fragrance in an amount of from 5 wt % to 20 wt %, or from 7.5 wt % to 15 wt %, based on the total weight of the granule.

In some embodiments, the fragrance material comprises a neat fragrance and an encapsulated fragrance, and the total amount of the neat fragrance and the encapsulated fragrance is at least 40 wt %, at least 50 wt %, at least 60 wt %, at least 70 wt %, at least 80 wt %, or at least 90 wt %, based on the total weight of the granule. In some embodiments, the weight ratio of the neat fragrance to the encapsulated fragrance is from 10:1 to 1:1. In some embodiments, the weight ratio of the neat fragrance to the encapsulated fragrance is from 8:1 to 2:1, or from 7:1 to 2:1, or from 6:1 to 3:1, or from 5:1 to 3:1. In some embodiments, the weight ratio of the neat fragrance to the encapsulated fragrance is at least 0.5:1, or at least 0.8:1, or at least 1:1, or at least 2:1, or at least 3:1. In some embodiments, the weight ratio of the neat fragrance to the encapsulated fragrance is no more than 15:1, or no more than 12:1, or no more than 11:1, or no more than 10:1, or no more than 9:1, or no more than 8:1, or no more than 7:1, or no more than 6:1, or no more than 5:1.

In some embodiments, the neat fragrance and/or the encapsulated fragrance comprises a fragrance ingredient having a log P value (partition coefficient) of less than 2. In some embodiments, the neat fragrance and/or the encapsulated fragrance comprises at least one, at least two, at least three, at least four, at least five, at least six, at least seven, at least eight, at least nine or at least ten High Performance fragrance ingredients selected from the group consisting of Ultra High-Impact fragrance ingredients as listed in Table 1 and High-Impact fragrance ingredients as listed in Table 2.

TABLE 1
Ultra High-Impact Fragrance Ingredients

| No. | Trade Name | CAS |
|---|---|---|
| 1. | ALD C-11 INTRELEVEN (TT) PRG | 143-14-6 |
| 2. | ALD C-6 TOCO | 66-25-1 |
| 3. | Musk Indenofuran (2,2,6,6,7,8,8- | 476332-65-7, |
| | heptamethyldecahydro-2H-indeno[4,5-b]furan) | 647828-16-8 |
| 4. | AMBERMOR EX | 6790-58-5 |
| 5. | AMBERMORKETAL | 57345-19-4 |
| 6. | AMBROCENIDE CRYST | 211299-54-6 |
| 7. | CALONE | 28940-11-6 |
| 8. | CITRYLAL BHT | 90480-35-6, |
| | | 147060-73-9 |
| 9. | CLONAL | 2437-25-4 |
| 10. | CREOSOL #340 | 93-51-6 |
| 11. | CRESYL ACET PARA COEUR | 140-39-6 |
| 12. | DECENAL,CIS-4 | 21662-09-9 |
| 13. | DODECENAL TRANS-2 TOCO | 20407-84-5 |
| 14. | DUPICAL TOCO | 30168-23-1 |
| 15. | DYNASCONE BHT | 56973-85-4 |
| 16. | FLORAL SUPER | 71077-31-1 |
| 17. | FRAGARONE | 16957-70-3 |
| 18. | GALBASCONE ALPHA 95 PRG | 56973-85-4 |
| 19. | GALBASCONE PRG TOCO | 56973-85-4, |
| | | 56973-84-3 |
| 20. | ISO BUTYL QUINOLINE | 67634-06-4 |
| 21. | ISO BUTYL THIAZOLE | 18640-74-9 |
| 22. | JAMUNATE | 7605-52-9 |
| 23. | KOUMALACTONE 10 PCT TEC FIRM | 77-93-0 |
| 24. | MANGONE CSM | 38462-22-5 |
| 25. | MELOZONE | 30772-79-3 |
| 26. | METH HEPTIN CARBONATE | 111-12-6 |
| 27. | METH LAITONE 10 PCT DPG | 110-98-5 |
| 28. | METH PHEN ETH ETHER | 3558-60-9 |
| 29. | NONADIENAL,2-TR-6-CIS TOCO | 557-48-2 |
| 30. | NONENOL,CIS-6 TOCO | 35854-86-5 |
| 31. | OPALENE TOCO | 174155-47-6 |
| 32. | ORENYLE | 29127-83-1 |
| 33. | ORRIS ALD TOCO | 60784-31-8 |
| 34. | OXANE 50 PCT TEC | 59323-76-1, |
| | | 59324-17-3 |
| 35. | PASSION FRUIT CMPD | 59323-76-1 |
| 36. | PHARAONE 10 PCT DPG | 110-98-5 |
| 37. | PYRAZINE 044 (METH) | 109-08-0 |
| 38. | ROSE OXIDE “L” TOCO | 16409-43-1 |
| 39. | ROSYRANE SUPER | 60335-71-9 |
| 40. | SACRAZOLE-018 | 137-00-8 |
| 41. | THIAZOLE (2-ISO PROP 4-METH) | 15679-13-7 |
| 42. | TRIDECENE-2-NITRILE | 22629-49-8 |
| 43. | TROPICALIA TOCO | 10138-32-6 |
| 44. | VIONIL NEAT | 67019-89-0 |
| 45. | HEALINGWOOD ¹ | Natural Oil |
| 46. | VIOLET LEAF ABS EGYPT LMR ¹ | Natural Oil |

¹ Available from International Flavors & Fragrances Inc.

TABLE 2
High-Impact Fragrance Ingredients

| No. | Trade Name | CAS |
|---|---|---|
| 1. | ACETOPHENONE | 98-86-2 |
| 2. | AGRUNITRILE | 51566-62-2 |
| 3. | ALD AA TRIPLAL BHT | 68039-49-6 |
| 4. | ALD C-10 | 112-31-2 |
| 5. | ALD C-11 MOA BHT | 19009-56-4 |
| 6. | ALD C-11 ULENIC TOCO | 112-45-8 |
| 7. | ALD C-11 UNDECYLIC TOCO | 112-44-7 |
| 8. | ALD C-12 LAURIC TOCO | 112-54-9 |
| 9. | ALD C-12 MNA TOCO | 110-41-8 |
| 10. | ALD C-16 STRAWB#2 | 77-83-8 |
| 11. | ALD C-18 | 104-61-0 |
| 12. | ALD C-8 TOCO | 124-13-0 |
| 13. | ALD C-9 TOCO | 124-19-6 |
| 14. | AMBERTONIC | 1392325-86-8 |
| 15. | AMBRETTOLIDE | 28645-51-4 |
| 16. | AQUAFLORA TOCO | 1339119-15-1 |
| 17. | BENZALD FFC | 100-52-7 |
| 18. | CASHMERAN | 33704-61-9 |
| 19. | CEDRAMBER | 67874-81-1 |
| 20. | CITRAL NEW | 5392-40-5 |
| 21. | COOLWOOD | 1340502-69-3 |
| 22. | CRESOL PARA EXTRA | 106-44-5 |
| 23. | CRISTALFIZZ | 1093653-57-6 |
| 24. | CYCLAPROP | 68912-13-0 |
| 25. | CYCLEMAX | 7775-00-0 |
| 26. | DAMASCENONE TOCO | 23696-85-7 |
| 27. | DAMASCONE DELTA | 71048-82-3 |
| 28. | DELPHONE | 4819-67-4 |
| 29. | DIPHEN OXIDE | 101-84-8 |
| 30. | DORIFFOX | 149713-23-5 |
| 31. | ETH ACETO ACET | 141-97-9 |
| 32. | ETH CAPROATE | 123-66-0 |
| 33. | ETH PHEN GLYC | 121-39-1 |
| 34. | ETH SAL | 118-61-6 |
| 35. | ETH-2-METH BUTY | 7452-79-1 |
| 36. | EUCALYPTOL USP | 470-82-6 |
| 37. | FLORHYDRAL TOCO (ELINCS) | 125109-85-5 |
| 38. | FRUITATE (ELINCS) | 129520-41-8 |
| 39. | HEXADECANOLIDE BHT | 109-29-5 |
| 40. | HEXENYL ISOBUTY, CIS-3 | 41519-23-7 |
| | (VERDURAL B) | |
| 41. | INDOLE | 120-72-9 |
| 42. | IONONE ALPHA TOCO | 127-41-3 |
| 43. | IRONE V BHT | 79-69-6 |
| 44. | ISO CYCLO CITRAL TOCO | 1423-46-7 |
| 45. | LACTONE OF CIS JASMONE TOCO | 70851-61-5 |
| 46. | LEMONILE | 61792-11-8 |
| 47. | MELONAL TOCO | 106-72-9 |
| 48. | MENTHONE 85 | 89-80-5 |
| 49. | METH BENZOATE | 93-58-3 |
| 50. | METH CINNAMATE TOCO | 103-26-4 |
| 51. | METH DH JASMONATE | 24851-98-7 |
| 52. | METH HEPTYL KETONE | 821-55-6 |
| 53. | METH JASMONATE TOCO | 39924-52-2 |
| 54. | METH OCTIN CARBONATE | 111-80-8 |
| 55. | METH PARA CRESOL | 104-93-8 |
| 56. | METH TUBERATE RD | 35205-76-6 |
| 57. | MUSCEMOR (ELINCS) | 82356-51-2 |
| 58. | MYRAC ALD BHT | 52475-89-5 |
| 59. | NECTARYL LRG 1371 ELINCS | 95962-14-4 |
| 60. | OCEANOL | 33662-58-7 |
| 61. | OPERANIDE (ELINCS) | 823178-41-2 |
| 62. | PHEN ETH ACET | 103-45-7 |
| 63. | PINEAPPLE CMPD | 3658-77-3 |
| 64. | PINO ACETALD TOCO | 33885-51-7 |
| 65. | ROSALVA | 13019-22-2 |
| 66. | ROSE OXIDE TOCO | 16409-43-1 |
| 67. | ROSETHYL | 64988-06-3 |
| 68. | SAFRALEINE | 54440-17-4 |
| 69. | SINFONIDE | 1315251-11-6 |
| 70. | STARFLEUR TOCO | 1254940-85-6 |
| 71. | SYLVONIC | 98-55-5 |
| 72. | TERPINOLENE P UB BHT | 586-62-9 |
| 73. | TOFFEE LACTONE 2067 | 705-86-2, |
| | | 706-14-9 |
| 74. | TOFFEETONE FOR NON TSCA USE ONLY | 13537-82-1 |
| 75. | TONKALACTONE | 54491-17-7 |
| 76. | TRIFERNAL BHT | 16251-77-7 |
| 77. | ULTRAVANIL Q COLIPA | 2563-07-7 |
| 78. | UNDECALACTONE, DELTA | 710-04-3 |
| 79. | UNDECAVERTOL TOCO | 81782-77-6 |
| 80. | VANITROPE | 94-86-0 |
| 81. | VARAMOL-106 | 7786-61-0 |
| 82. | VELTOL PLUS | 4940-11-8 |
| 83. | VERAMOSS | 4707-47-5 |
| 84. | VERIDIAN | 811412-48-3 |
| 85. | VERTOLIFF TOCO | 36635-35-5 |
| 86. | VERTONIC | 1945993-03-2 |
| 87. | VETIVER ACET HAITI TOCO BLO | 84082-84-8 |
| 88. | YARA YARA | 93-04-9 |
| 89. | YLANGANATE | 89-71-4 |
| 90. | ARMOISE OIL PURE ¹ | Natural oil |
| 91. | BLKCURRANT BUD ABS BURGUNDY | Natural oil |
| | LMR FOR LIFE ¹ | |
| 92. | CHAMOMILE OIL ENG ³ | Natural oil |
| 93. | CHAMOMILE OIL ROMAN LMR SFO ¹ | Natural oil |
| 94. | CINNAMON BARK ESSENTIAL LMR ¹ | Natural oil |
| 95. | DAVANA OIL LMR FLG SFO ¹ | Natural oil |
| 96. | EUGENOL NAT EX CLOVE LEAF OIL | Natural oil |
| 97. | JASMIN ABS EGYPT LMR ¹ | Natural oil |
| 98. | ORANGE FLOWER WATER ABS TUNISIA | Natural oil |
| | LMR ¹ | |
| 99. | OSMANTHUS ABS LMR ¹ | Natural oil |
| 100. | PATCHOULI OIL LIGHT BLO ² | Natural oil |
| 101. | PEPPER PINK CO2 LMR ¹ | Natural oil |
| 102. | ROSE ABS DAMASCENA PURE BLO ¹ | Natural oil |
| 103. | SINENSAL NATURAL 20 EX ORANGE ³ | Natural oil |
| 104. | THYME OIL WHITE SPAIN BLO ¹ | Natural oil |

¹Available from International Flavors & Fragrances Inc (New York).
² Available from TRIPPER PTE Ltd. (Indonesia).
³ Available from TREATT & CO. Ltd. (United Kingdom).

In some embodiments, the neat fragrance and/or the encapsulated fragrance may further comprise at least one additional fragrance ingredients. In some embodiments, the neat fragrance and/or the encapsulated fragrance may further comprise 1, 2, 3, 4, 5, 6, 7, 8, 9, 10, 15, 20, 25, 30, 35, 40 or more additional fragrance ingredients. Non-limiting examples of such additional fragrance ingredients include those described in US2018/0325786A1, U.S. Pat. Nos. 4,534,891, 5,112,688, and 5,145,842, the content of each of them is incorporated herein by reference. In some embodiments, the additional fragrance ingredients, when combined with one or more fragrance ingredients of Tables 1 and 2, constitute the total fragrance material composition present in the granule of the present disclosure.

In some embodiments, the carbohydrate carrier is selected from the group consisting of starch, modified starch, polysaccharide (e.g., gum Arabic), cellulose, pectin, and mixtures thereof. In some embodiments, the carbohydrate carrier comprises a starch selected from the group consisting of corn starch, potato starch, rice starch, tapioca starch, and mixtures thereof. In some embodiments, these starches can be chemically modified (i.e., modified starch). The starch of the present disclosure can be obtained from seeds, roots or tubers. The starch can be obtained by wet grinding, washing, sieving and drying. Starches are predominantly obtained from corn, wheat and potato, and to a lesser extent, sources such as rice, sweet potato, sago and mung bean. The starch can be unmodified or chemically modified (i.e., modified starch) to allow the starch to function under conditions frequently encountered during processing or storage, such as high heat, high shear, low pH, oxidation, freeze/thaw and/or cooling. Such modifications include, but are not limited to acid treatment, alkaline treatment, bleaching, oxidation, enzyme treatment, acetylation, phosphorylation, or a combination thereof. In some embodiments, the carbohydrate carrier comprises or is a modified starch. In some embodiments, the modified starch is selected from the group consisting of cationic starches, hydroxyethyl starches, carboxymethylated starches, and combinations thereof. In some embodiments, the modified starch is an octenyl succinic anhydride (OSA) modified starch. In some embodiments, the modified starch is starch sodium octenyl succinate (E1450). Other types of modifications known to those skilled in the art will also be considered within the scope of the present disclosure. Suitable examples of modified starches include, but are not limited to, CAPSUL®, CAPSUL® FP, HI-CAP® IMF, HI-CAP® 100 (starch sodium octenyl succinate) and the like (available from Ingredion, Westchester, IL, USA). In some embodiments, the aqueous (modified) starch solution may include maltose, sucrose, maltodextrin, or a combination thereof. In some embodiments, the aqueous (modified) starch solution may include a cellulose ether.

In some embodiments, the carbohydrate carrier comprises a modified starch and an unmodified starch. As used herein, the term “unmodified starch” means that the starch is not chemically modified. In some embodiments, the carbohydrate carrier comprises gum Arabic. In some embodiments, the carbohydrate carrier is present in the granule in an amount of from 10 wt % to 50 wt %, preferably from 20 wt % to 40 wt %, based on the total weight of the granule. In some embodiments, the fragrance material is adsorbed into or absorbed onto the carbohydrate carrier.

In some embodiments, the fragrance-containing granule of the present disclosure can further comprise an additional component such as a friability reducing agent selected from the group consisting of glycerin, corn syrup, gelatin, polyvinylpyrrolidone, polyvinyl alcohol, and combinations thereof. The friability reducing agent can reduce the friability of the granule. In some embodiments, the friability reducing agent comprises or is glycerin. In some embodiments, the amount of the friability reducing agent present in the granule is from 1 wt % to 10 wt %, from 2 wt % to 8 wt %, or from 3 wt % to 7 wt %, based on the weight of the granule. In some embodiments, the amount of the friability reducing agent present in the granule is at least 0.5 wt %, or at least 1 wt %, or at least 2 wt %, or at least 3 wt %, or at least 4 wt %, or at least 5 wt %, based on the weight of the granule. In some embodiments, the amount of the friability reducing agent present in the granule is no more than 12 wt %, or no more than 11 wt %, or no more than 10 wt %, or no more than 9 wt %, or no more than 8 wt %, or no more than 7 wt %, based on the weight of the granule.

In some embodiments, the fragrance-containing granule of the present disclosure can further comprise one or more additional components selected from the group consisting of surfactant, enzyme, anti-microbial agent, anti-malodor agent, soil release polymer, anti re-deposition polymer, probiotic, softening agent, chelating agent, anti-static, and combinations thereof. In some embodiments, this can lead to single granule combining several active ingredients to make a finished laundry or cleaning product without having to post dose or blend products.

### Process for Preparing the Granules

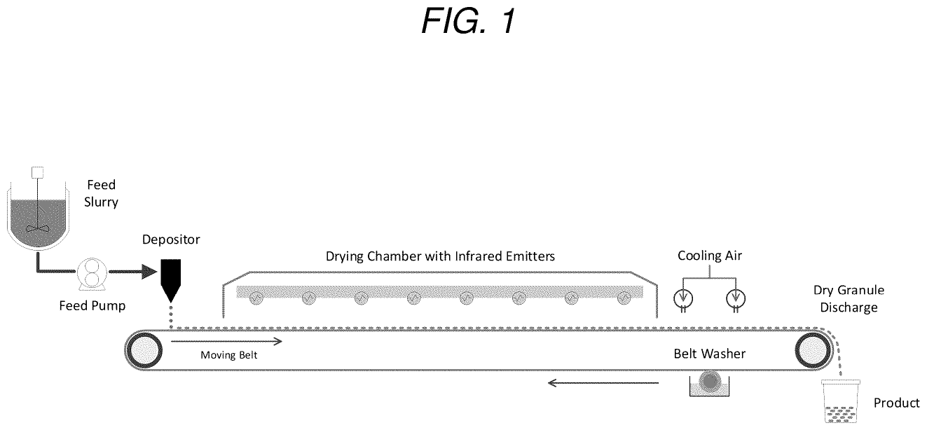

In some embodiments, the fragrance-containing granule of the present disclosure can be prepared according to the following method. There may be alternatives to the method, so there is no limitation regarding the way to obtain the granules provided that a high fragrance loading can be obtained. Thus, according to an embodiment, the fragrance-containing granules are obtained by a process as shown in FIG. 1. With reference to FIG. 1, the process may comprise the following steps:
(i) Preparing a water phase having high solid content (e.g., 68-70 wt %) and high viscosity (5,000-10,000 cP) by dissolving and/or dispersing the carbohydrate carrier with water,
(ii) Preparing an oil phase comprising the fragrance material (neat and encapsulated) and mixing the oil phase with the water phase of step (i) to obtain an oil-in-water emulsion (feed slurry in FIG. 1),
(iii) Mixing the emulsion of step (ii) with a high-shear disperser (IKA T50 Ultra-Turrax) to undergo high shear mixing (e.g., 13500 RPM) to reduce the oil droplet size to <5 microns,
(iv) Dispensing (using Depositor in FIG. 1) 3 mm diameter droplets or dots of the emulsion feed of step (iii) onto a conveyor belt at belt speed of 10 meter per minute, and
(v) Drying the dots by applying heat to them as they move along the conveyor belt to obtain the fragrance-containing granules of the present disclosure. Other drying method such as fluidized bed, or even a drying at room temperature can be suitable.

### Consumer Products

In another aspect, the present disclosure relates to a consumer product comprising the fragrance-containing granule of the present disclosure. In some embodiments, the consumer product is a particulate laundry detergent comprising a major proportion of a detergent particles and a minor proportion of the fragrance-containing granules (e.g., in an amount ranging from about 0.1% to about 30%, preferably from about 0.5% to about 20%, or more preferably from about 1% to about 15%, based on the total weight of such particulate laundry detergent). In some embodiments, the consumer product consists of the fragrance-containing granule. In some embodiments, the consumer product is a scent booster, a fabric refresher, a laundry detergent (powdered), a fabric softener, a rinse-aid, a water-softening agent, a bleach-booster, a sanitizing agent, a unit dose laundry detergent, a detergent granule, a detergent tablet, a laundry sachet, or a cleaning composition. Preferably the consumer product is a scent booster. As the scent booster provides strong scent to the laundry, it can be used with other laundry additives such as detergents or fabric softeners. Thus, another object of the present disclosure is a laundry composition comprising the scent booster and a laundry additive selected from a detergent, a fabric softener, a rinse-aid, or a bleach-booster product. Another object of the present disclosure is the use of the scent booster during the laundering to provide fragrance to fabrics.

In yet another aspect, the present disclosure relates to use of the above-mentioned consumer product for hand-washing fabrics. According to a particular embodiment, the present disclosure relates to a method of using a laundry composition for hand-washing fabrics, comprising the steps of: (a) providing such laundry composition; (b) forming a laundry liquor by diluting the laundry composition with water at a weight ratio of from about 1:100 to about 1:1000; (c) hand-washing fabrics in the laundry liquor; and (d) rinsing the fabric with water. In another embodiment, the present disclosure relates to use of the above-mentioned laundry composition for machine washing fabrics.

Many aspects and embodiments have been described above and are merely exemplary and not limiting. After reading this specification, skilled artisans appreciate that other aspects and embodiments are possible without departing from the scope of the invention. All publications cited herein are incorporated by reference in their entirety.

### Test Methods

The following test methods set forth must be used in order that the invention described and claimed herein may be more fully understood.

### Test Method 1: Dissolution Rate Test

The Dissolution Rate Test is used to measure the speed of dissolution of the granules. This test is conducted by adding 99.0 g of de-ionized water into a 400 mL transparent beaker at room temperature (25° C.). Set the beaker on a stir/hotplate. Place conductivity probe (Fisher Conductivity Meter) into the beaker with a clamp. Turn on conductivity meter and set stirring speed to 500 RPM. Add 1.0 g of granules to the mixing water, and start the timer. When the conductivity meter reading plateaus, the meter will flash “READY” status and the timer is stopped. The elapsed time is recorded which is the dissolution rate of the granule (i.e., total time needed for the granules to be fully dissolved).

### Test Method 2: Skeletal Density Test (i.e., Porosity Test)

The Porosity Test is used to measure the relative volume of porosity contained within the internal structure of granule, (i.e., intra-granule porosity). The principle of Applicant's Porosity Test follows that of published International Standard ISO 15901-01: Evaluation of pore size distribution and porosity of materials by mercury porosimetry and gas adsorption-Part 1: Mercury Porosimetry. Porosity falls into two categories: inter-granule (voids in-between granules) and intra-granule porosity (pores within granules). The current method is used to measure the intra-granule porosity. The details of the method, as adapted to the present disclosure, are as follows.

A granule sample of about 2 cm³ volume with granule size from 300 μm to 600 μm by sieve classification is loaded into the Penetrometer assembly having a suitable bulb and stem assembly to ensure greater than 25% and less than 75% stem volume usage over the pressure range specified in part 3. The sample assembly is then evacuated to remove gas from pores.

Dry nitrogen is introduced into the evacuated measuring cell in a controlled manner to increase the pressure (either in stages, continuously or by step-wise pressurization) according to the proper equilibration conditions for mercury entering the pores and with precision required for the particular pores size range of interest, covering at least up to 0.2 MPa, corresponding to 6 μm pore size diameter. Pressure and corresponding volume of mercury intruded can be recorded either graphically or via a computer. When the maximum required pressure has been reached, the pressure is reduced to ambient and the sample holder is transferred to the high-pressure unit.

In the high pressure unit, pressure is increased via intrusion of mercury (as a hydraulic fluid) by step-wise pressurization according to the proper equilibration conditions for mercury entering the pores, with precision required for the particular pores size range of interest, covering at least up to 400 MPa, corresponding to 3 nm pore diameter. As a consequence, mercury is pressed into the pore system and the decreasing length of the mercury column is measured as a function of pressure. Pressure and corresponding volume of mercury intruded can be recorded via a computer.

The pressure exerted is inversely proportional to the clear width of the pore entrance. For pores of cylindrical shape the Washburn equation gives the relation between pressure and diameter: dₚ=−4γ cos θ/P, in which dₚ is pore size diameter, γ is surface tension of mercury [N·m⁻¹], θ is contact angle, and P is the intrusion pressure. Generally used values for surface tension and contact angle of mercury are 480 mN·m⁻¹ and 140°, respectively. Using the Washburn equation the pressure readings are converted to pore size diameter. The intruded volume related to sample mass as ordinate in dependence of the pore diameter as abscissa is plotted to give the pore volume distribution.

The cumulative pore volume distribution includes both interstitial and intra-granule porosity. Within the bounds of the present disclosure, the threshold intra-granule pore size has been determined using a differential distribution analysis: 30 μm is cut-off pore size; pores larger than 30 μm are considered as inter-granule; and pores smaller than 30 μm is considered intra-granule. The intra-granule porosity is calculated by intra-granule pore volume divided by the sum of the intra-granule pore volume and the solid volume of the granule sample. The solid volume of the sample is the sample volume minus the total pore volume.

### EXAMPLES

The following non-limiting examples are provided to further illustrate the present invention and are not to be construed as limitations of the invention, as many variations of the present invention are possible without departing from its spirit or scope.

### Example 1—Preparation of Granules Comprising Both Neat Fragrance and Encapsulated Fragrance

The composition of the fragrance-containing granule is shown in Table 3 below. In a suitable vessel, the prescribed amount of water was added and it was heated to about 60° C. With continuous mixing, sodium sulfate was added and mixed until it was fully dissolved. Capsul® modified starch was slowly added to minimize clumping and mixing continued until it was fully dissolved. The resultant solution was cooled to about 30° C. The viscosity of the solution was checked with the Brookfield Viscometer using spindle #7 at 60 RPM. The viscosity value was high as 30,000 cPs.

In a separate vessel, the prescribed amount of a neat fragrance oil was added. While the homogenizer, IKA Turrax® T-50 (available from IKA-Werke GmbH & Co. KG, Staufen, Germany), was immersed in the starch and sodium sulfate solution, the neat fragrance oil was added slowly into the solution until the neat fragrance vessel was empty. Continuous high shearing at 13500 RPM for a minimum of 5 minutes. The viscosity of the resulting oil-in-water emulsion was checked with the Brookfield viscometer using spindle #7 at 60 RPM. The viscosity value was high as 30,000 cPs. Also, the particle size distribution of the oil droplets in the emulsion was checked. A target Mean of <10 micron and a target Mode of <3 micron was achieved.

While continuously mixing the emulsion, a microcapsule slurry containing an encapsulated fragrance was slowly added into the emulsion at the prescribed amount. The weight ratio of the neat fragrance to the encapsulated fragrance was 4:1 in the granules prepared in this Example 1. Again, viscosity of the resulting emulsion was checked with the Brookfield Viscometer using spindle #4 at 60 rpm. The viscosity value was high as 10,000 cPs.

Finally, while mixing, rice starch was added into the emulsion at the prescribed amount to generate the emulsion feed (i.e., feed slurry) to be used in the printing process as depicted in FIG. 1. Viscosity of the resulting emulsion was checked again using spindle #4 at 60 rpm. The viscosity value was high as 15,000 cPs.

As shown in FIG. 1, the emulsion feed (i.e., feed slurry) generated above was deposited onto a conveyor belt as 3 mm diameter droplets or dots. The conveyor belt moved at belt speed of 10 meter per minute. The dots were dried in the drying chamber with infrared light to generate the fragrance-containing granules of the present disclosure.

TABLE 3
Composition of the Granule

| Ingredients | Wet (g) |
|---|---|
| Water | 444.81 |
| Capsul ® modified starch ¹ | 370.51 |
| Sodium sulfate | 67.00 |
| Neat fragrance | 536.00 |
| Microcapsule slurry | 423.03 |
| Rice starch | 158.66 |
| Total | 2000.00 |

¹ available from Ingredion, Westchester, IL, USA.

### Example 2 (Comparative)—Preparation of Granules Comprising Only Encapsulated Fragrance

Granules were prepared following procedures of Example 1 except that the composition of the fragrance-containing granule is shown in Table 4 below (no neat fragrance was used).

TABLE 4
Composition of the Granule

| Ingredients | Wet (g) |
|---|---|
| Water | 1337.09 |
| Capsul ® modified starch ¹ | 577.28 |
| Sodium sulfate | 104.50 |
| Neat fragrance | 0.00 |
| Microcapsule slurry | 352.56 |
| Rice starch | 247.39 |
| Total | 2618.82 |

¹ available from Ingredion, Westchester, IL, USA.

### Example 3 (Comparative)—Preparation of Spray Dry Samples

Spray-dried particles were prepared using the same emulsion (Table 3) as prepared in Example 1, except that the emulsion was diluted with 680 g of additional water to reduce the viscosity of the emulsion to a few hundred centipoises to be suitable for spray drying process. The resulting emulsion was spray dried using well-known spray drying technology to generate the spray-dried particles (spray dry sample). The weight ratio of the neat fragrance to the encapsulated fragrance was 4:1 in the spray dry sample.

### Example 4 (Comparative)—Preparation of PEG Beads (i.e., PEG Based Scent Booster)

85.59 g of Pluriol® E 8000 PEG (polyethylene glycol) was added into a 150 mL glass beaker with an IKA Eurostar overhead mixer. A 72° C. hot water bath was used as the heat source for the beaker to melt PEG. The overhead mixer was turned on part way through the melting process when the PEG material can be freely stirred and set at a low speed (75 rpm). It took approximately 30 minutes to fully melt the PEG.

Once the PEG was fully melted, the overhead mixer was set at a low speed (75 rpm) and 6.41 g of a microcapsule slurry containing 2.0 g of encapsulated fragrance was slowly added into the melted PEG. While continuously mixing the PEG/microcapsule mixture at 75 rpm, 8.0 g of a neat fragrance oil was added into the mixture, and the water bath was reset to 70° C.

While continuously mixing the PEG/microcapsule/neat fragrance molten mixture, a 5 mL syringe was inserted into the molten mixture to draw a 5 mL molten sample into the syringe. The molten sample was evenly dispensed as small droplets onto a room temperature baking sheet. The droplets were cooled and collected as PEG beads from the baking sheet. The generated PEG beads contain the neat fragrance and the encapsulated fragrance in a weight ratio of 4:1.

### Example 5 (Comparative)—Preparation of HPMC High-Fragrance Granules

30 g of Methocel™ K4M HPMC powder was added on a stainless steel tray to form an HPMC powder bed. A pipette was used to deposit 10 g of a microcapsule slurry (containing 2.8 g of encapsulated fragrance) in the form of droplets onto the HPMC powder bed. The droplets were deposited onto the powder bed in a pattern or array such that the droplets were evenly distributed and spaced. Afterwards, a pipette was used again to deposit 11.2 g of a neat fragrance in the form of droplets onto the HPMC powder bed. The neat fragrance was deposited on the microcapsule droplet spots as well as between the microcapsule droplets. The stainless steel tray was then put into an oven set at 50-200° C. for 30 minutes. After that, the tray was taken out from the oven and cooled to room temperature.

The product in the tray was screened through a 60 mesh (250 micron) screen, and the HPMC granule products were collected on the screen. Some HPMC powders went through the screen. It was found that the HPMC granules (containing neat fragrance and encapsulated fragrance) were not in uniform size. Some HPMC granules were chunky and in the order of several centimeters, while some other HPMC granules were significantly smaller. The neat fragrance oil acted as an agglomeration agent to the HPMC powder, and some large agglomerates were obtained after drying in the oven. Agglomeration also rendered inconsistent/non-uniform distribution of the fragrance material.

### Example 6—Dissolution and Residue Evaluation

A study was conducted to assess the dissolution of various scent booster samples (see Table 5 below) in water temperature-controlled wash cycles. The sample amount was determined so that 0.5 g of fragrance equivalent can be delivered per wash.

TABLE 5
Scent Booster Samples for Dissolution and Residue Evaluation

| Testing Samples | Amount (g) | Preparation |
|---|---|---|
| Granule of the present disclosure | 5 | Example 1 |
| Spray-dried particle | 5 | Example 3 |
| PEG bead | 25 | Example 4 |
| HPMC granule | 0.81 | Example 5 |

The prescribed amount of a testing sample was placed inside a black cotton blend drawstring bag (6×8 inch) and washed in a Speed Queen® stackable washer under the conditions listed below:

### Washing Conditions:

Wash Cycle—Quick Wash (30 minutes wash cycle)
Temperature—Cold Setting
Soil Level—Medium
Spin Speed—Medium

Upon wash completion, the washed black cotton blend drawstring bags were turned inside out and inspected. The visual inspection found that the granule of the present disclosure, spray-dried particle and HPMC granule samples were all completely dissolved under the washing conditions of the test (wash cycle and water temperature). There was no visual sign of sample residue left behind on the black cotton blend drawstring bags after wash with these samples. However, the visual inspection found a significant amount of PEG bead residue left on the black cotton blend drawstring bag after wash with the PEG bead sample. This demonstrated the PEG bead sample was not fully dissolved under the washing conditions of the test.

### Example 7—Fragrance Performance Evaluation

To evaluate fragrance performance, the fragrance intensity of the fragrances contained in the scent booster samples listed in Table 6 below was evaluated by conducting a laundry experiment. The sample amount was determined so that 0.5 g of fragrance equivalent can be delivered per wash.

TABLE 6
Scent Booster Samples for Fragrance Performance Evaluation

| Testing Samples | Amount (g) | Preparation |
|---|---|---|
| Granule of the present disclosure | 5 | Example 1 |
| Granule without neat fragrance | 5 | Example 2 |
| Spray-dried particle | 5 | Example 3 |
| PEG bead | 25 | Example 4 |
| HPMC granule | 0.81 | Example 5 |

The laundry experiments were conducted following the procedures described below:
Washer Settings:
   Permanent Press
   Temperature: Cold
   Medium Speed Spin
   Soil Level: Medium
Dryer Settings: 60 minutes time setting (medium)
Laundry process:
   Set washer to above settings.
   Load drum with 4 lbs. load of clothes.
   Add 50 g of fragrance-free Tide® Free and Clear detergent into detergent drawer.
   Add the prescribed amount of a scent booster sample listed in Table 6 directly into drum.
   Close the washer door and start washing.
   When the washing is completed, remove clothes from the washer and place them into dryer at 60 minutes medium setting.

The fragrance intensity and performance were evaluated by a group of evaluators at three different stages (damp, pre-rub, and post-rub) and rated on a scale ranging from 0 to 5. A numerical value of 0 indicates that the fabric produced no signs of released fragrance, and 5 indicates a very strong smell of released fragrance. “Damp” refers to the stage that clothes have been washed but not dried yet (i.e., clothes have been removed from the washer, but before being placed into dryer). “Pre-rub” refers to the stage that clothes have been dried (in the dryer) but before the dry clothes being folded or rubbed. “Post-rub” refers to the stage that clothes have been dried (in the dryer) and the dry clothes have been rubbed 3 times using both hands to rupture the microcapsules deposited on the clothes.

At each of the three different stages (damp, pre-rub, and post-rub), the evaluator smelled a cloth and evaluated for signs of released fragrance from the cloth. The results were recorded and shown in Table 7 below.

TABLE 7
Sensory Evaluation Results

| | Damp | Pre-rub | Post-rub |
|---|---|---|---|
| Testing Samples | Evaluation | Evaluation | Evaluation |
| Granule of the present disclosure | 3.24 | 3.70 | 4.10 |
| Granule without neat fragrance | 2.75 | 3.48 | 3.90 |
| Spray-dried particle | 3.44 | 3.51 | 3.75 |
| PEG bead | 3.04 | 3.65 | 3.80 |
| HPMC granule | 1.92 | 2.31 | 2.75 |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination.

1. A fragrance-containing granule comprising:
(a) a fragrance material comprising a neat fragrance and an encapsulated fragrance; and
(b) a carbohydrate carrier;
wherein the amount of the fragrance material is greater than 40 wt %, 45 wt %, 50 wt %, 55 wt %, or 60 wt %, based on the weight of the granule;
the weight ratio of the neat fragrance to the encapsulated fragrance is from 10:1 to 1:1; and
the granule has a skeletal density of greater than 1.00 g/mL or 1.05 g/mL.

2. The granule of claim 1, wherein the granule has an Average Mean Diameter in the range of 1 mm to 5 mm, or 2 mm to 3 mm.

3. The granule of claim 1, wherein the granule comprises one or more intra-granule air voids, and the granule is characterized by a dissolution rate of no more than 1 minute or 30 seconds as measured in deionized water at 25° C. according to the Dissolution Rate Test described herein.

4. The granule of claim 1, wherein the granule has:
(a) water activity (a_{w}) of <0.6 at 25° C.; and/or
(b) an average granular weight of 1 mg to 10 mg, or 3 mg to 7 mg; and/or
(c) a bulk density of 0.1 g/mL to 1 g/mL, or 0.2 g/mL to 0.6 g/mL.

5. The granule of claim 1, wherein the granule has a particle size dispersity index (PSDI) of <0.2 (St. Dev/Mean).

6. The granule of claim 1, wherein the weight ratio of the fragrance material to the carbohydrate carrier is from 9:1 to 1:1.

7. The granule of claim 1, wherein the granule has a bio-renewable carbon (BRC) content of at least 50%, at least 55%, at least 60%, at least 65%, at least 70%, at least 75%, at least 80%, at least 85%, at least 90%, or at least 95%, based on the weight of the granule.

8. The granule of claim 1, wherein the carbohydrate carrier comprises starch, modified starch, polysaccharide, cellulose, and/or pectin.

9. The granule of claim 8, wherein the carbohydrate carrier comprises modified starch.

10. The granule of claim 1, wherein the fragrance material comprises:
(i) from 30 wt % to 45 wt %, or from 25 wt % to 42.5 wt % neat fragrance, based on the total weight of the granule; and
(ii) from 5 wt % to 20 wt %, or from 7.5 wt % to 15 wt % encapsulated fragrance, based on the total weight of the granule.

11. The granule of claim 1, wherein the encapsulated fragrance is encapsulated by a biodegradable microcapsule shell, preferably the biodegradable microcapsule shell has a biodegradation rate of at least 60%, at least 65%, at least 70%, at least 75%, at least 80%, at least 85%, at least 90%, at least 95% or at least 98%, based on the weight of the microcapsule shell, within 60 days according to OECD301F.

12. The granule of claim 1, wherein the carbohydrate carrier has a melting point temperature of ≥70° C., ≥80° C., ≥90° C., or ≥ 100° C.

13. A process for treating laundry comprising the step of dosing to a laundry load in a washing machine or in a wash basin from 1 g to 30 g, preferably from 3 g to 20 g of the granule of claim 1.

14. A consumer product comprising the fragrance-containing granule of claim 1, preferably the consumer product is a scent booster, a fabric refresher, a detergent (powdered), a fabric softener, a rinse-aid, a water-softening agent, a bleach-booster, a sanitizing agent, a unit dose laundry detergent, a detergent granule, a detergent tablet, a laundry sachet or a cleaning composition.
